(19) United States
(12) Patent Application Publication
(10) Pub. No.: US 2026/0116143 A1
(43) Pub. Date: Apr. 30, 2026

(54) TUBE MUFFLER FOR LOW FREQUENCY REFRIGERANT NOISE ATTENUATION

(71) Applicant: Hanon Systems, Daejeon (KR)

(72) Inventors: Yafei Zhou, Canton, MI (US); Petr Czyz, Hodslavice (CZ)

(21) Appl. No.: 18/926,576

(22) Filed: Oct. 25, 2024

(51) Int. Cl. B60H 1/00

(52) U.S. Cl. CPC B60H 1/00571; B60H 2001/006

(57) ABSTRACT

A refrigerant muffler includes an elongate hollow interior defined by cooperation of an axially extending circumferential wall, a first axial end wall, and a second axial end wall disposed opposite the first axial end thereof. A first port for conveying a refrigerant into or out of the hollow interior is provided as a first opening extending through the circumferential wall to an inner circumferential surface thereof. A second port for conveying the refrigerant into or out of the hollow interior is provided as a second opening extending through the circumferential wall to the inner circumferential surface thereof. The first port is axially spaced apart from each of the first axial end wall and the second axial end wall and the second port is axially spaced apart from each of the first axial end wall and the second axial end wall.

### FIELD OF THE INVENTION

The invention relates to a refrigerant circuit having a refrigerant muffler incorporated therein as a noise attenuation device, and more particularly, a refrigerant muffler formed by an elongate tubular structure having an inlet and an outlet thereof spaced apart from opposing ends of the elongate tubular structure for providing improved noise attenuation at relatively low frequencies.

### BACKGROUND

Vehicular air-conditioning systems commonly employ a compressor to circulate a refrigerant through various components of a corresponding refrigerant circuit. Such compressors tend to operate in a cyclical manner wherein the refrigerant repeatedly exits the compressor as pulses of relatively high-pressure refrigerant. These pulses of high-pressure flow can result in relatively inconsistent flow of the refrigerant through the refrigerant circuit components as well as the generation of noise that can propagate throughout such refrigerant circuit components. This noise can be undesirable to the passengers of a vehicle having such an air-conditioning system incorporated therein.

To mitigate compressor noise and to smooth out the flow of refrigerant, mufflers have been utilized in refrigerant circuits at a position immediately upstream or immediately downstream of the corresponding compressor where the refrigerant is gaseous in phase. Conventional refrigerant mufflers typically consist of a housing with an inlet, an outlet, and an expansion chamber having an increased flow cross-section located between the inlet and outlet. Such a conventional refrigerant muffler typically includes the expansion chamber thereof having a cylindrical shape that extends in an axial direction of the refrigerant muffler such that the refrigerant passing therethrough generally flows rectilinearly when traversing the expansion chamber from the inlet to the outlet. The expansion chamber, the inlet, and the outlet are provided in a specific configuration wherein acoustic waves of a specific range of frequencies reflect at an outlet end of the expansion chamber to interfere with new acoustic waves entering the expansion chamber at the inlet end thereof, thereby attenuating acoustic waves of certain preselected frequencies. The effectiveness of such refrigerant mufflers to attenuate noise at a given frequency may be measured in terms of what is referred to as the acoustic transmission loss of the associated refrigerant muffler, wherein increased transmission loss at a given frequency is associated with an improvement in the attenuation of noise, vibration, and harshness (NVH) at the given frequency.

As electric vehicles become more mainstream, there is an increased need for heating, ventilating, and air conditioning (HVAC) systems having modified constructions and modes of operation to account for the different circumstances associated with the operation of such electric vehicles in comparison to a traditional HVAC system of a vehicle utilizing an internal combustion engine (ICE). Such modified HVAC systems may include a compressor of the corresponding HVAC system typically operating at a lower frequency and/or utilizing a higher-pressure refrigerant (such as R744) than in many traditional HVAC systems, thereby requiring the associated refrigerant muffler to be able to attenuate acoustic waves at lower ranges of frequencies, while maintaining the strength and durability to potentially withstand such high-pressure refrigerants. For example, such HVAC systems may utilize an electrically powered scroll compressor as the compression means of an associated refrigerant circuit. Such scroll compressors typically include only one instance of high-pressure refrigerant discharge for each associated compression cycle thereof, which results in such scroll compressors generating lower frequencies of refrigerant pressure pulsations in comparison to rotary compressors having a plurality of compression chambers that each respectively generate such a pressure pulsation with respect to each complete cycle of the rotary compressor. For example, a variable displacement swash plate type compressor having five to seven compression chambers circumferentially arranged relative to a corresponding swash plate may correspondingly generate five to seven pressure pulsations via a single rotary cycle of the swash plate type compressor. It is thus necessary to provide the refrigerant muffler associated with such a scroll compressor to include the ability to attenuate noise with respect to relatively lower operating frequencies than would be the case with respect to a comparable rotary compressor.

One approach to improve the transmission loss for relatively lower frequencies (<200 Hz) of acoustic waves in the conventional refrigerant muffler includes increasing the inner diameter of the cylindrically shaped expansion chamber thereof. However, this results in the refrigerant muffler occupying a larger cylindrical volume within the HVAC system, which is often not able to be readily accommodated by the limited package space available in modern vehicles where components are tightly packaged to minimize wasted space and to improve the efficiency of operation of various systems of the corresponding vehicle. That is, the axially extending and cylindrical shape of such conventional refrigerant mufflers does not provide a desired degree of flexibility in terms of the possible arrangements of the conventional refrigerant muffler relative to the adjacent components of the corresponding vehicle while still achieving the desired transmission loss with respect to the desired range(s) of frequencies of acoustic waves. This concern may be further exacerbated when utilizing one of the above-mentioned relatively high-pressure refrigerants, such as R744, as the thickness of the wall of the expansion chamber must also be increased to strengthen the structure of the conventional refrigerant muffler for accommodating the increased hoop stress experienced within the expansion chamber as a result of the increase in the inner diameter thereof. That is, such an increase in wall thickness further increases the outer diameter of the expansion chamber, which in turn further limits the ability to package such a conventional refrigerant muffler in a space efficient manner.

Therefore, there is a need for a refrigerant muffler that effectively suppresses noise generated by the compressor at relatively lower frequencies of acoustic waves, that withstands relatively higher internal pressures as may be caused by the user of relatively higher-pressure refrigerants, and that presents a configuration having an increased degree of flexibility and adaptability to different packaging configurations of the associated HVAC system and/or adjacent systems of a corresponding vehicle.

### SUMMARY OF THE INVENTION

In accordance with the present disclosure, a refrigerant muffler having a reduced profile and improved adaptability of design while attenuating noise with respect to relatively lower ranges of frequencies of acoustic waves has surprisingly been discovered.

According to an embodiment of the present invention, a refrigerant muffler includes an elongate hollow interior defined by cooperation of an inner circumferential surface of an axially extending circumferential wall, a first axial end wall disposed at a first axial end of the circumferential wall, and a second axial end wall disposed at a second axial end of the circumferential wall opposite the first axial end thereof. A first port for conveying a refrigerant into or out of the hollow interior of the refrigerant muffler is provided as a first opening extending through the circumferential wall to the inner circumferential surface thereof. A second port for conveying the refrigerant into or out of the hollow interior of the refrigerant muffler is provided as a second opening extending through the circumferential wall to the inner circumferential surface thereof. The first port is axially spaced apart from each of the first axial end wall and the second axial end wall and the second port is axially spaced apart from each of the first axial end wall and the second axial end wall.

According to another embodiment of the invention, a refrigerant muffler includes an elongate hollow interior defined by cooperation of an inner circumferential surface of an axially extending circumferential wall, a first axial end wall disposed at a first axial end of the circumferential wall, and a second axial end wall disposed at a second axial end of the circumferential wall opposite the first axial end thereof. A first port for conveying a refrigerant into or out of the hollow interior of the refrigerant muffler is provided as a first opening extending through the circumferential wall to the inner circumferential surface thereof. A second port for conveying the refrigerant into or out of the hollow interior of the refrigerant muffler is provided as a second opening extending through the circumferential wall to the inner circumferential surface thereof. The first port is positioned within a central region of the hollow interior with respect to the axial direction of the circumferential wall to result in an axial distance at which the first port is spaced apart from the second axial end wall, as measured along a central axis of the hollow interior, being 45% to 55% of a total length of the hollow interior as measured along the central axis of the hollow interior between the first axial end wall and the second axial end wall. The second port is positioned axially between the first port and the second axial end wall. An axial distance at which the second port is spaced apart from the second axial end wall, as measured along the central axis of the hollow interior, is 5% to 45% of the total length of the hollow interior as measured along the central axis thereof between the first axial end wall and the second axial end wall. The total length of the hollow interior is 5 to 30 times greater than an inner diameter of the hollow interior as defined by the inner circumferential surface of the circumferential wall.

According to yet another embodiment of the invention, a refrigerant circuit includes, in an order of flow of a refrigerant during circulation thereof through the refrigerant circuit, a compressor, a refrigerant muffler, a condenser, an expansion element, and an evaporator. The refrigerant muffler includes an elongate hollow interior defined by cooperation of an inner circumferential surface of an axially extending circumferential wall, a first axial end wall disposed at a first axial end of the circumferential wall, and a second axial end wall disposed at a second axial end of the circumferential wall opposite the first axial end thereof. A first port for conveying the refrigerant into the hollow interior of the refrigerant muffler after exiting from a high-pressure side of the compressor and before entering the condenser is provided as a first opening extending through the circumferential wall to the inner circumferential surface thereof. A second port for conveying the refrigerant out of the hollow interior of the refrigerant muffler and towards the condenser is provided as a second opening extending through the circumferential wall to the inner circumferential surface thereof. The first port is axially spaced apart from each of the first axial end wall and the second axial end wall, and the second port is axially spaced apart from each of the first axial end wall and the second axial end wall.

### BRIEF DESCRIPTION OF THE DRAWINGS

FIG. 1 is a schematic view of a generalized refrigerant circuit having a refrigerant muffler incorporated thereon;

FIG. 2 is an elevational side view of a refrigerant muffler according to an embodiment of the present invention;

FIG. 3 is an elevational cross-sectional view of the refrigerant muffler of FIG. 2 as taken from the perspective of sections lines 3-3 of FIG. 2;

FIG. 4A is an elevational view of a refrigerant muffler having a relatively large diameter expansion chamber according to the prior art;

FIG. 4B is an elevational view of a refrigerant muffler having a relatively small diameter expansion chamber and relatively elongate configuration;

FIG. 4C is an elevational view of a refrigerant muffler according to an embodiment of the present invention wherein a second port of the refrigerant muffler is spaced apart from an end of the refrigerant muffler by about ⅓ of the length of the refrigerant muffler;

FIG. 4D is an elevational view of a refrigerant muffler according to another embodiment of the present invention wherein a second port of the refrigerant muffler is spaced apart from an end of the refrigerant muffler by about ¼ of the length of the refrigerant muffler;

FIG. 4E is an elevational view of a refrigerant muffler according to an embodiment of the present invention wherein a second port of the refrigerant muffler is spaced apart from an end of the refrigerant muffler by about 9/20 of the length of the refrigerant muffler;

FIG. 5 is a chart showing the transmission loss (dB) achieved at different frequencies (Hz) of acoustic waves with respect to each of the refrigerant mufflers disclosed throughout FIGS. 4A-4E;

FIG. 6 is a perspective view of a refrigerant muffler according to another embodiment of the present invention wherein the refrigerant muffler extends longitudinally in a substantially U-shaped configuration;

FIG. 7 is a right-side elevational view of the refrigerant muffler having the U-shaped configuration as disclosed in FIG. 6;

FIG. 8 is a rear elevational view of the refrigerant muffler having the U-shaped configuration as disclosed in FIG. 6;

FIG. 9 is an elevational cross-sectional view of the refrigerant muffler having the U-shaped configuration as disclosed in FIG. 6 as taken from the perspective of section lines 9-9 in FIG. 8;

FIG. 10 is a perspective view of a refrigerant muffler according to another embodiment of the present invention wherein the refrigerant muffler extends longitudinally in a substantially S-shaped configuration;

FIG. 11 is a right-side elevational view of the refrigerant muffler having the S-shaped configuration as disclosed in FIG. 10;

FIG. 12 is a rear elevational view of the refrigerant muffler having the S-shaped configuration as disclosed in FIG. 10;

FIG. 13 is an elevational cross-sectional view of the refrigerant muffler having the S-shaped configuration as disclosed in FIG. 10 as taken from the perspective of section lines 13-13 in FIG. 12; and

FIGS. 14A-14E illustrate various exemplary embodiments of refrigerant mufflers according to the present disclosure wherein potential combinations and/or variations of the features disclosed with regards to the refrigerant mufflers of FIGS. 6-13 are shown for exemplifying the flexibility of packaging such refrigerant mufflers within an irregular or complex packaging space within a corresponding vehicle.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

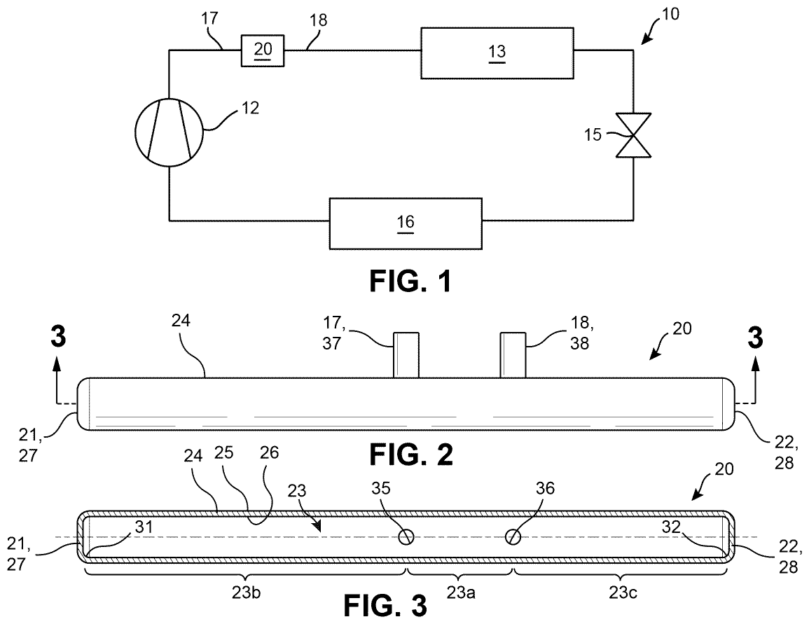

FIG. 1 schematically illustrates a refrigerant circuit 10 having a refrigerant muffler 20 installed therealong according to an embodiment of the present invention. The refrigerant circuit 10 may be incorporated in a vehicle, such as a hybrid or electric vehicle, relying upon stored electrical power to provide heat to various components of the vehicle and/or air to be delivered to the passenger cabin of the vehicle via the operation of the refrigerant circuit 10. However, the present invention may be utilized in any refrigerant circuit that is utilized for any application without necessarily departing from the scope of the present invention.

The refrigerant circuit 10 includes, in an order of flow of a refrigerant therethrough, a compressor 12, the refrigerant muffler 20, a condenser/gas cooler 13, an expansion element 15, and an evaporator/chiller 16. The compressor 12 is configured to compress and heat the refrigerant to a relatively high-temperature and high-pressure gaseous refrigerant, the condenser/gas cooler 13 is configured to transfer heat away from the gaseous refrigerant to a first heat exchange fluid in order to cool and (preferably completely) condense the refrigerant to a relatively lower temperature liquid refrigerant (or in some circumstances a liquid/gas mixture), the expansion element 15 is configured to contract and then expand the liquid refrigerant (or liquid/gas mixture) to further lower the temperature and pressure of the liquid refrigerant (or liquid/gas mixture) to produce a relatively low-temperature and low-pressure liquid refrigerant or liquid/gas mixture of low-temperature and low-pressure refrigerant, and the evaporator/chiller 16 is configured to transfer heat from a second heat exchange fluid to the low-temperature and low-pressure liquid refrigerant or liquid/gas mixture to evaporate any remaining liquid refrigerant to result in a relatively low-pressure gaseous refrigerant.

The refrigerant circuit 10, as illustrated, is simplified in form and may include any additional components or alternative flow paths associated with varying the mode of operation of the refrigerant circuit 10 while remaining within the scope of the present invention. For example, additional components that may be utilized in such a refrigerant circuit 10 may include a receiver drier (not shown) disposed between the condenser/gas cooler 13 and the expansion element 15, an accumulator (not shown) disposed between the evaporator/chiller 16 and a low-pressure side of the compressor 12, an internal heat exchanger (not shown) for exchanging heat between a portion of the refrigerant exiting the condenser/gas cooler 13 and a portion of the refrigerant exiting the evaporator/chiller 16, and/or a valve arrangement (not shown) for switching a flow direction of the refrigerant through the refrigerant circuit 10 such that the illustrated condenser/gas cooler 13 and evaporator/chiller 16 switch functions for altering the heat transfer with respect to the first and second heat exchange fluids, such as when attempting to heat air delivered to a passenger compartment of an associated vehicle or to heat or cool coolant(s) associated with various components of the vehicle in need of heating or cooling to maintain desirable operation thereof.

The refrigerant muffler 20 is disclosed as being disposed immediately downstream of the compressor 12 to receive a flow of the relatively high-pressure, gaseous refrigerant after exiting the high-pressure (discharge) side of the compressor 12. The refrigerant muffler 20 may be provided at the disclosed position to ensure that the refrigerant passing therethrough is gaseous in form to provide preferable conditions for attenuating noise originating from the refrigerant. The disclosed position of the refrigerant muffler 20 may also be selected to aid in reducing pressure pulsations with the refrigerant as caused by the cyclical nature of the operation of the compressor 12, thereby aiding in smoothing out the flow of the refrigerant along the remainder of the refrigerant circuit 10 substantially immediately after exiting the compressor 12. However, the refrigerant muffler 20 is not necessarily limited to receiving the high-pressure discharge refrigerant therein, and may alternatively be positioned immediately upstream of the compressor 12 in order to receive the relatively low-pressure, gaseous form of the refrigerant prior to the refrigerant entering the compressor 12 via the low-pressure (suction) side thereof without necessarily departing from the scope of the present disclosure.

FIGS. 2 and 3 illustrate an embodiment of the refrigerant muffler 20, referred to as simply the muffler 20 hereinafter for brevity, according to the present invention. The muffler 20 is formed by a tubular structure that extends longitudinally from a first end 21 to an opposing second end 22 thereof. As utilized herein, the longitudinal direction of the muffler 20 is also considered the axial direction thereof, thereby such terms may be used interchangeably herein in describing the direction of extension of the muffler 20 when progressing from one end 21, 22 thereof to the other end 21, 22 thereof. The tubular structure of the illustrated embodiment is formed by a circumferential wall 24 that is cylindrical in shape and thus includes an outwardly facing and cylindrically shaped outer circumferential surface 25 as well as an inwardly facing and cylindrically shaped inner circumferential surface 26 circumferentially defining the hollow interior 23 of the tubular structure. Although the hollow interior 23 is shown and described throughout as utilizing the disclosed cylindrical shape having a substantially circular cross-sectional shape arranged on a plane that is perpendicular to the longitudinal/axial direction of the tubular structure along the length of the muffler 20, it should be apparent to one skilled in the art that alternative cross-sectional shapes of the hollow interior 23 may be adapted for prescribing the noise attenuation in the manner described herein without necessarily departing from the scope of the present invention, so long as the remaining aspects of the configuration of the muffler 20 are in accordance with the disclosure provided herein regarding the method of noise attenuation occurring within the muffler 20. The alternative cross-sectional shapes may include a rounded rectangular cross-sectional shape or an elliptical cross-sectional shape, as non-limiting examples.

The muffler 20 includes a first axial end wall 27 at the first end 21 thereof and a second axial end wall 28 at the second end 22 thereof, wherein each of the axial end walls 27, 28 delimit the hollow interior 23 at the opposing ends thereof such that the tubular structure forming the muffler 20 may be said to be closed off or to include closed ends at each of the opposing longitudinal/axial ends 21, 22 thereof. The axial end walls 27, 28 may also be said to partially define the hollow interior 23 by way of defining the axial ends thereof, thereby resulting in the hollow interior 23 generally being defined by the cooperation of the axial end walls 27, 28 and the longitudinally/axially extending inner circumferential surface 26 of the circumferential wall 24. In the presently disclosed embodiment, the muffler 20 thus may be said to include the configuration of a length of a cylindrical pipe or cylindrical conduit that is closed at each of the opposing ends thereof. As shown, each of the axial end walls 27, 28 may be arranged on a plane perpendicular to the longitudinal/axial direction of the circumferential wall 24 of the muffler 20 immediately adjacent each of the respective axial end walls 27, 28. The first axial end wall 27 may be connected to the inner circumferential surface 26 via an arcuate connecting surface 31 extended annularly and circumferentially about the peripheral of the circular first axial end wall 27 and the second axial end wall 28 may similarly be connected to the inner circumferential surface 26 via an arcuate connecting surface 32 extended annularly and circumferentially about a periphery of the circular second axial end wall 28 to prevent the formation of a sharp corner about the periphery of each respective axial end wall 27, 28 where the axial end walls 27, 28 connect to the circumferential wall 24.

The hollow interior 23 of the muffler 20 is fluidly coupled to the remainder of the refrigerant circuit 10 via each of a first port 35 and an independently provided and longitudinally/axially spaced apart second port 36. The first port 35 and the second port 36 are each formed by openings extending through the circumferential wall 24 of the muffler 20 to the inner circumferential surface 26 thereof such that each of the ports 35, 36 extends radially inwardly through the circumferential wall 24 to fluidly connect to the hollow interior 23 of the muffler 20. Each of the ports 35, 36 may thus be arranged relative to the hollow interior 23 such that any refrigerant entering or exiting the hollow interior 23 is flowing in a direction perpendicular to the longitudinal/axial direction of the tubular muffler 20 at the longitudinal/axial position along the muffler 20 corresponding to each respective port 35, 36. Each of the ports 35, 36 may include a substantially cylindrical shape having a circular cross-section as can be seen from the viewing perspective of FIG. 3, which is directed in parallel to the axial direction of each such cylindrically shaped port 35, 36. Each of the ports 35, 36 includes an inner diameter and corresponding flow area therethrough that is less than an inner diameter and corresponding flow area of the hollow interior 23 as defined by the inner circumferential surface 26 of the circumferential wall 24. According to one non-limiting example, each of the ports 35, 36 may include an inner diameter that is about 15-40% of the inner diameter of the hollow interior 23 as defined by the inner circumferential surface 26 thereof.

The ports 35, 36 of the illustrated embodiment are also formed to a common diametric side of the cylindrical shape of the circumferential wall 24 (meaning the ports 35, 36 have the same angular position with respect to the circular cross-sectional shape of the circumferential wall 24) such that the refrigerant entering or exiting the muffler 20 via the first port 35 flows therethrough in a radial direction of the muffler 20 that is parallel to and opposing a radial direction at which the refrigerant enters or exits the muffler 20 via the second port 36 with respect to the instantaneously disclosed embodiment thereof. However, the ports 35, 36 need not be provided to the same diametric side of the circumferential wall 24 in accordance with the present invention, as it has been surprisingly discovered that an angular displacement present between the positions of the ports 35, 36 along the circumferential wall 24 does not negatively affect the beneficial characteristics of the present invention regarding the attenuation of acoustic waves. For example, the ports 35, 36 may be formed to opposing diametric sides of the circumferential wall 24 (180 degrees of angular displacement) or may be displaced by 90 degrees of angular displacement, as non-limiting examples of alternative angular configurations. The ability to alter the angular orientation of such ports 35, 36 around the circumferential wall 24 thus leads to increased flexibility of design of the corresponding muffler 20 that promotes the ability to position the muffler 20 relative to fluid lines such as the disclosed lines 17, 18 with respect to additional or contrary packaging configurations, such as introducing such lines 17, 18 at diametrically opposing sides of the circumferential wall 24 or at 90 degree angular displacements relative thereto, which is in contrast to the need to form the inlet and outlet into a conventional muffler at each of the opposing axial ends thereof.

As shown in by comparison of FIGS. 2 and 3, the first port 35 may be associated with a first pipe 37 extending radially outwardly from the outer circumferential surface 25 of the circumferential wall 24 and the second port 35 may similarly be associated with a second pipe 38 extending radially outwardly from the outer circumferential surface 25 of the circumferential wall 24. The first pipe 37 may be formed by a portion of or may otherwise be associated with a first fluid line 17 of the refrigerant circuit 10 fluidly connecting the discharge or high-pressure side of the compressor 12 to the first port 35 of the muffler 20 while the second pipe 38 may be formed by a portion of or may otherwise be associated with a second fluid line 18 of the refrigerant circuit 10 fluidly connecting the second port 36 of the muffler 20 to the condenser 13. As mentioned above, it is conceivable that the muffler 20 may be arranged upstream of the compressor 12 such that the first pipe 37 may instead be formed by or otherwise be associated with the fluid line (not labeled) connecting the evaporator 16 with the first port 35 and the second pipe 38 may be formed by or may otherwise be associated with the fluid line (not labeled) connecting the second port 36 to the suction or low-pressure side of the compressor 12, depending on the configuration of the instantaneous refrigerant circuit 10. In either event, it should be understood that substantially any structure, coupling, fitting, piping, or conduit may be associated with fluidly coupling each of the ports 35, 36 to the remaining components of the refrigerant circuit 10 without necessarily departing from the scope of the present invention, so long as the ports 35, 36 are present within the corresponding circumferential wall 24 and lead directly into the hollow interior 23 of the muffler 20 in a manner promoting the operation of the muffler 20 as shown in described herein.

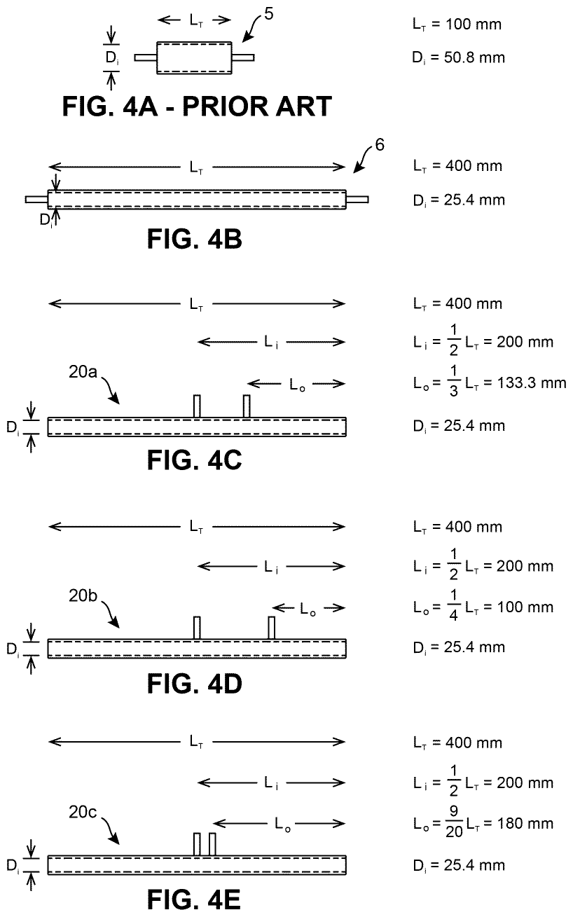

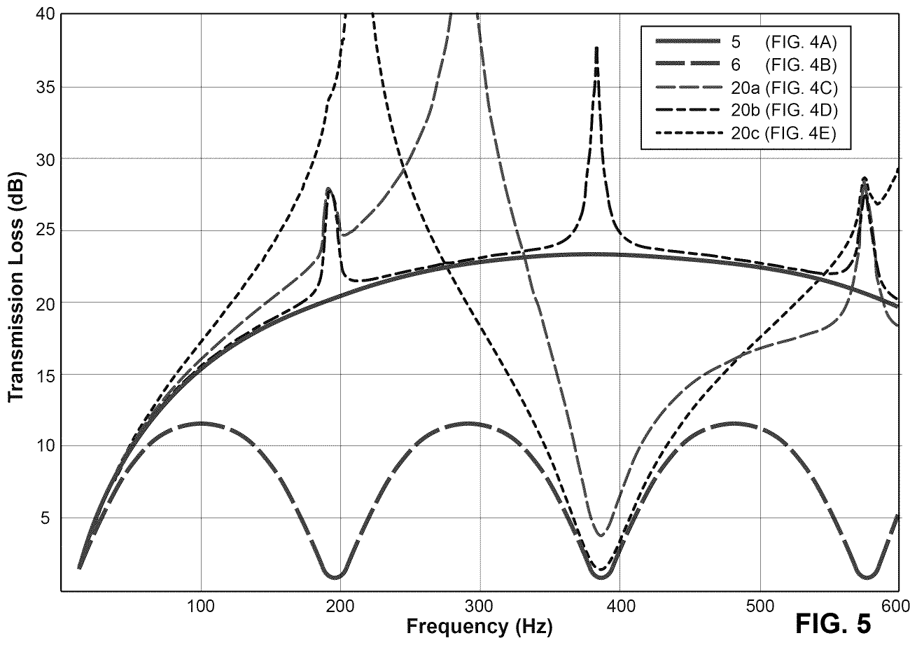

The above-described configuration of the fluid lines 17, 18 relative to the position of the muffler 20 along the refrigerant circuit 10 corresponds to the first port 35 being an inlet port 35 of the muffler 20 and the second port 36 being an outlet port 36 thereof. However, it has surprisingly been discovered that the beneficial properties of the disclosed muffler 20 can be appreciated regardless of which of the ports 35, 36 forms the inlet into the muffler 20 and which of the ports 35, 36 forms the outlet from the muffler 20, as the same attenuation of acoustic waves occurs within the muffler 20 regardless of the direction of flow of the refrigerant within the mufflers 20 and between the two distinct ports 35, 36. The testing of various embodiments of the muffler 20 as shown and described with reference to the examples of FIGS. 4C-4E hereinafter (the results of which are summarized in the chart of FIG. 5) was conducted with what is identified as the first port 35 acting as the inlet port 35 and what is identified as the second port 36 acting as the outlet port 36 with respect to such exemplary embodiments, hence discussion of operation of the muffler 20 may typically refer to a flow direction from the first port 35 toward the second port 36 when discussing the different embodiments of the muffler 20, although such discussion should in no way be considered to be limiting to the operation of the present invention.

The muffler 20 according to the present invention includes each of the first port 35 and the second port 36 spaced apart from each of the longitudinal ends 21, 22 and corresponding axial end walls 27, 28 with respect to the longitudinal/axial direction of the muffler 20 such that the refrigerant passing therethrough primarily flows directly between the first port 35 and the second port 36 along a first segment 23a of the hollow interior 23 without having to necessarily traverse either of a second segment 23b of the hollow interior 23 extending between the first port 35 and the first axial end wall 27 or a third segment 23c of the hollow interior 23 extending between the second port 36 and the second axial end wall 28. The refrigerant flowing between the first port 35 and the second port 36 along the first segment 23a experiences only a minor degree of expansion and subsequent contraction when flowing therealong such that the refrigerant does not experience an especially high pressure drop when flowing through the muffler 20 during circulation through the refrigerant circuit 10, despite the second segment 23b and the third segment 23c potentially occupying a majority of the volume of the hollow interior 23. That is, the second segment 23b and the third segment 23c are not arranged such that the open spaces formed thereby contribute significantly to the expansion of the refrigerant when entering the hollow interior 23 and traversing the first segment 23a because the refrigerant remains substantially stagnant within each of the axially outer disposed segments 23b, 23c in comparison to the flow of the refrigerant along the identified first segment 23a.

The muffler 20 promotes the attenuation of certain, preselected ranges of frequencies of acoustic waves passing through the muffler 20 as a result of such acoustic waves tending to traverse the outer disposed segments 23b, 23c of the hollow interior 23 in a manner promoting the reflection of such acoustic waves at each of the axial end walls 27, 28 for promoting destructive interference of the desired range of frequencies of the acoustic waves. That is, although the refrigerant passing through the hollow interior 23 primarily flows directly between the first port 35 and the second port 36 along the first segment 23a, the acoustic waves traveling with the refrigerant when entering the hollow interior 23 by way of either of the first port 35 or the second port 36 tend to divide and propagate towards each of the opposing axial end walls 27, 28 in a manner promoting such destructive interference.

For example, with respect to a flow configuration where the first port 35 acts as the inlet port 35 and the second port 36 acts as the outlet port 36, the acoustic waves traveling through the second segment 23b and towards the first axial end wall 27 are eventually reflected at the first axial end wall 27 such that the reflected acoustic waves then travel back through the second segment 23b and towards the first port 35 while destructively interfering with the acoustic waves flowing in the opposite direction along the second segment 23b after initially entering the hollow interior 23 by way of the first port 35. The same effect occurs with respect to the acoustic waves exiting the first port 35 and flowing towards the second axial end wall 28 along the first and third segments 23a, 23c except that the presence of the second port 36 along the disclosed pathway tends to alter the manner in which the destructive interference occurs between the first port 35 and the second axial end wall 28. Specifically, at least a portion of the acoustic waves traveling towards the second axial end wall 28 by way of the first segment 23a will exit the hollow interior 23 at the second port 36 while a remainder of the acoustic waves continuing to travel towards the second axial end wall 28 by way of the third segment 23c will reflect off of the second axial end wall 28 in a manner promoting destructive interference of the reflected acoustic waves with those acoustic waves originating from the first port 35 and traveling beyond the second port 36 when traveling towards the second axial end wall 28. As mentioned above, similar effects are also found to occur when the flow direction of the refrigerant instead includes the refrigerant entering the second port 36 as the inlet port 36 to flow towards the first port 35 as the outlet port 35, despite the reversal of flow direction.

It has surprisingly been discovered that varying the relative positions of the first port 35 and the second port 36 relative to the longitudinal/axial direction of the muffler 20 for altering the relative lengths of the identified segments 23a, 23b, 23c of the hollow interior 23 leads to the ability to effectively tune the muffler 20 for increasing the transmission loss of certain ranges of frequencies of such acoustic waves in accordance with desirable characteristics of the muffler 20 when the refrigerant circuit 10 operates according to at least some modes of operation thereof wherein relatively low frequencies of the acoustic waves are in need of attenuation, such as those frequencies below about 200 Hz. The ability to alter this attenuating effect via a mere repositioning of one or both of the ports 35, 36 along the length of the muffler 20 is advantageous in comparison to the techniques associated with tuning a conventional refrigerant muffler having the inlet and outlet thereof arranged at opposing ends of an expansion chamber having an increased inner diameter in comparison to that of each of the inlet and the outlet, which generally results in the need to increase the inner diameter of the expansion chamber to achieve such an effect. That is, the present invention allows for a tubular structure forming the muffler 20 to be modified for achieving the desired attenuating effect without having to alter (increase) the length and/or the inner diameter of the muffler 20 in a manner increasing the packaging space of the muffler 20, which in many vehicular applications is extremely limited or restrictive with respect to the shape of the available packaging space, with respect to various spatial dimensions of the packaging space, and/or with respect to the total volume available within the packaging space. The muffler 20 can accordingly be provided to include a relatively low profile (diameter) such that the muffler 20 may be routed between adjacent components of the refrigerant circuit 10 and/or other closely situated components of the vehicle while achieving the advantages of the present invention.

It has been discovered that placement of the first port 35 at a centrally located position that is substantially equally spaced apart from each of the axial end walls 27, 28 with respect to the longitudinal/axial direction of the muffler 20 allows for the tuning of the muffler 20 to attenuate desired ranges of the frequencies of the acoustic waves via a repositioning of only the second port 36 along the longitudinal/axial direction at positions between the first port 35 and the second axial end wall 28 towards which the second port 36 is disposed relative to the first port 35. That is, the second segment 23b may be selected to comprise about half of the total length of the hollow interior 23 while the first segment 23a and the third segment 23c, in combination, may be selected to also comprise a length equal to about half of the total length of the hollow interior 23 such that a repositioning of the second port 36 along the specified range of positions alters a respective percentage that each of the first segment 23a and the third segment 23c contributes to the approximately half of the length of the hollow interior 23.

Referring now to FIGS. 4A-4E, various different configurations of mufflers are disclosed that all have a common interior volume (˜202,683 mm²) but vary relative to one another via at least one of a total length L_{T} of the corresponding muffler, an inner diameter Dᵢ of the corresponding muffler, an orientation of an inlet and/or outlet of the corresponding muffler, or a positioning of the inlet and/or outlet of the corresponding muffler with respect to the longitudinal/axial direction thereof. FIG. 4A discloses a general configuration of a muffler 5 that corresponds to what has been described herein as a conventional muffler configuration according to the prior art wherein the corresponding inlet and outlet are arranged at opposing ends of an expansion chamber that includes an increased inner diameter in comparison to either of the inlet or the outlet. As indicated in FIG. 4A, the muffler 5 includes a total length L_{T} of the expansion chamber thereof that is 100 mm and an inner diameter of the expansion chamber thereof that is 50.8 mm (2 inches), wherein the inlet and the outlet of the expansion chamber are arranged in parallel alignment along a central axis of the expansion chamber at opposing ends thereof. FIG. 4B discloses another muffler 6 of substantially conventional design where the dimensions of the muffler 6 are significantly different from those of the muffler 5 such that the muffler 6 has a total length L_{T} and an inner diameter Dᵢ that matches that of each of the mufflers 20a, 20b, 20c of disclosed with respect to FIGS. 4C-4E (all of which generally correspond to the description of the muffler 20 as disclosed with respect to FIGS. 2 and 3 but with varying positions of the second port 36 thereof). However, the muffler 6 differs from the mufflers 20a, 20b, and 20c by means of the inlet and the outlet thereof again being arranged in parallel alignment along the central axis of the muffler 6 and spaced apart from one another by the total length L_{T} of the muffler 6 such that the inlet and the outlet are associated with opposing axial end walls of the muffler 6.

Specifically, the muffler 6 includes a total length L_{T} of the expansion chamber thereof that is 400 mm and an inner diameter of the expansion chamber thereof that is 25.4 mm (1 inch). The muffler 6 is thus not considered to be admitted prior art due to such dimensions not normally be employed in forming such an expansion chamber, thus the muffler 6 is included herein for comparing the different results when considering the distinctions between the muffler 6 and each of the mufflers 20a, 20b, 20c despite the same general dimensions being utilized therein.

Each of the mufflers 20a, 20b, and 20c of FIGS. 4C-4E include a same total length L_{T} of 400 mm, the same length Lᵢ of 200 mm that the first port 35 is spaced apart from what is referred to above as the second axial end wall 28 (the end wall towards which the second port 36 of each embodiment is disposed), and the same inner diameter Dᵢ of 25.4 mm (1 inch) of the hollow interior 23 along all corresponding segments 23a, 23b, 23c thereof. The mufflers 20a, 20b, 20c differ from one another in that a length Lₒ corresponding to a distance at which the second port 36 is spaced apart from the second axial end wall 28, which also corresponds to the length of the third segment 23c identified in FIG. 3, varies among the different mufflers 20a, 20b, 20c. Specifically, the muffler 20a of FIG. 4C includes the length Lₒ being ⅓ of the total length L_{T} (˜133.33 mm; also corresponding to the illustration of the muffler 20 in FIGS. 2 and 3), the muffler 20b of FIG. 4D includes the length Lₒ being ¼ of the total length L_{T} (˜200 mm), and the muffler 20c of FIG. 4E includes the length Lₒ being 9/20 of the total length L_{T} (˜180 mm).

FIG. 5 is a chart showing a comparison of the transmission loss in decibels (dB) that is achieved via each of the disclosed mufflers 5, 6, 20a, 20b, 20c as determined by experimentation regarding the disclosed dimensions and configurations thereof as outlined in FIGS. 4A-4E, which all correspond to the centrally disposed port 35, 36 forming an inlet and the port 35, 36 displaced from the central position towards one of the axial ends 27, 28 forming an outlet according to the experiments in question, although a reversal of such flow does not alter the results of the disclosed experiments. Each of the mufflers 20a, 20b, 20c according to the present disclosure can be seen in FIG. 5 to include a significant upward departure (improvement) in transmission loss relative to the conventional muffler 5 with respect to those frequencies falling between about 150 Hz and 200 Hz, and especially with respect to those frequencies falling between about 180 Hz and 200 Hz, wherein each such curve deviates upwardly to indicate an increase in transmission loss of at least 7 dB with respect to at least one frequency (about 190 Hz) between 180 Hz and 200 Hz. It is also apparent that the muffler 6, which includes the conventional configuration while sharing the dimensions of L_{T} and Dᵢ with each of the mufflers 20a, 20b, 20c according to the present disclosure, attenuates the acoustic waves in a cyclical manner (repeating about every 190 Hz) while achieving significantly lower values of transmission loss across all frequencies less than about 350 Hz and all frequencies greater than about 450 Hz in comparison the mufflers 20a, 20b, 20c, thereby indicating the apparent influence of the differing orientation and the positioning of the first and second ports 35, 36 with respect to each of the mufflers 20a, 20b, 20c when compared to the conventional configuration of the muffler 6 having the inlet and outlet thereof axially aligned and opposing each other.

The muffler 20a of FIG. 4C includes a noticeably improved attenuation of the acoustic waves as indicated by relatively increased values of transmission loss in comparison to the conventional muffler 5 of FIG. 4A along those frequencies ranging from about 100 Hz to about 330 Hz with localized maximums of about 28 dB of transmission loss at frequencies between about 180 Hz and about 200 Hz and greater than 40 dB of transmission loss at frequencies between about 280 Hz and about 300 Hz. The muffler 20a of FIG. 4C then shows decreased values of the transmission loss relative to the muffler 5 of FIG. 4A between frequencies of about 330 Hz to about 570 Hz with a localized minimum value of transmission loss of about 4 dB at about 380 Hz before the muffler 20a of FIG. 4C achieves improved values of transmission loss relative to the muffler 5 of FIG. 4A for frequencies between about 570 Hz and about 580 Hz with another localized maximum of transmission loss of about 28 dB occurring at a frequency of about 575 Hz. Similarly, the muffler 20c of FIG. 4E includes a noticeably improved attenuation of the acoustic waves as indicated by relatively increased values of transmission loss in comparison to the conventional muffler 5 of FIG. 4A along those frequencies ranging from about 100 Hz to about 275 Hz with a localized maximum of greater than 40 dB of transmission loss at frequencies between about 200 Hz and about 220 Hz. The muffler 20c of FIG. 4E then shows decreased values of the transmission loss relative to the muffler 5 of FIG. 4A between frequencies of about 275 Hz to about 540 Hz with a localized minimum value of transmission loss of about 2 dB at about 380 Hz before the muffler 20c of FIG. 4E again achieves improved values of transmission loss relative to the muffler 5 of FIG. 4A for frequencies greater than about 540 Hz with another localized maximum of transmission loss of about 28 dB occurring at a frequency of about 575 Hz.

Each of the mufflers 20a and 20c may accordingly be selected for use in those refrigerant circuits expected to normally be operated at relatively low frequencies (less than about 330 Hz with respect to the muffler 20a and less than about 275 Hz with respect to the muffler 20c) while potentially being avoided for utilization for use in those refrigerant circuits expected to normally be operated at relatively moderate frequencies, and especially those frequencies within the range of about 350 Hz to 450 Hz. Each of the mufflers 20a and 20c may also be suited for use in refrigerant circuits that may commonly operate at frequencies of greater than about 550 Hz with respect to at least one mode of operation thereof where the measured transmission loss values are substantially equivalent to or exceed those of the conventional muffler 5.

The muffler 20b of FIG. 4D achieves transmission losses that substantially mimic those achieved by the conventional muffler 5 of FIG. 4A along the entire range of illustrated frequencies (between about 20 Hz and about 600 Hz) while the muffler 20b also beneficially achieves periodic localized maximums of transmission loss that exceed those values achieved by the muffler 5 by about 8 dB at about 190 Hz, by about 15 dB at about 380 Hz, and by about 6 dB at about 575 Hz. The muffler 20b may accordingly be suitable and selected for use in refrigerant circuits for which the muffler 5 of conventional design is otherwise currently suitable for use, but the muffler 20b also provides the added benefit of significantly improving the transmission loss achieved in comparison to the conventional muffler 5 at specific ranges of frequencies that may be associated with commonly employed modes of operation of such refrigerant circuits, and especially those refrigerant circuits expected to be operated at about 180 Hz to about 200 Hz, at about 370 Hz to about 400 Hz, and/or at about 560 Hz to 590 Hz.

Each of the mufflers 20a, 20b, 20c accordingly shows improved transmission loss for countering noise, vibration, and harshness with respect to at least one range of frequencies expected to be encountered within a corresponding refrigerant circuit in comparison to the muffler 5 of conventional design while also occupying only about ¼ of the cross-sectional flow area therethrough, which significantly alters the available packaging configurations within an associated vehicle by allowing for the routing of such relatively low profile mufflers 20a, 20b, 20c alongside or between adjacent components where relatively small gaps are available for inclusion of components such as a refrigerant muffler. As mentioned in the background section of the present patent application, a scroll compressor as may be utilized in conjunction with such refrigerant mufflers 20a, 20b, 20c may typically be provided to generate pressure pulsations at a relatively lower maximum frequency (often in the range of 180-200 Hz) in comparison to a rotary compressor (such as a swash plate type compressor) due to fewer pressure pulsations resulting from each complete cycle of such a scroll compressor in comparison to a multi-chambered rotary compressor. As shown in FIG. 5, each of the tested mufflers 20a, 20b, 20c shows a noticeable improvement in attenuating noise with respect to such a range of maximum frequencies in comparison to the more traditional muffler 5, and especially in view of the manner in which each of the mufflers 20a, 20b, 20c displays a localized peak of transmission loss occurring along the designated range of frequencies. Each of the mufflers 20a, 20b, 20c also has similar or slightly improved noise attenuating characteristics for all such frequencies less than such a maximum frequency of 200 Hz, thereby establishing that any of the tested mufflers 20a, 20b, 20c may act as a substitute for the conventional muffler 5 when utilized in conjunction with such a scroll compressor regardless of the mode of operation thereof, including when relatively low demands are being placed on the scroll compressor. Additionally, it is also apparent that each of the mufflers 20a, 20b, 20c can also be adapted for use in conjunction with an alternative form of compressor operating at a relatively higher frequency than such a scroll compressor due to each of the mufflers 20a, 20b, 20c having additional localized peaks at frequencies well beyond 200 Hz, hence the configuration of such mufflers 20a, 20b, 20c may be utilized in substantially any circumstance in accordance with the present disclosure.

The ability to achieve suitable transmission losses in the mufflers 20a, 20b, 20c with respect to such ranges of frequencies while utilizing only half the radius/diameter in the mufflers 20a, 20b, 20c in comparison to the conventional muffler 5 also comparatively improves the strength and durability of such mufflers 20a, 20b, 20c in withstanding relatively strong internal pressures as imparted by the refrigerant passing therethrough. This occurs because the hoop stress experienced within axially symmetric structures such as the disclosed mufflers 5, 20a, 20b, 20c is generally proportional to the radius/diameter thereof, wherein a reduced radius/diameter results in a lowering of the stresses experienced within the corresponding circumferential wall of such structures when exposed to the same internal pressure value. The hoop stress experienced within the mufflers 20a, 20b, 20c may accordingly be about half that experienced within the conventional muffler 5 having twice the radius/diameter when exposed to refrigerant having the same pressure value.

Additionally, the hoop stress experienced within such axially symmetric structures is also inversely proportional to the thickness of the corresponding circumferential wall defining the axially symmetric shape thereof with respect to the same internal pressure value such that a doubling of the thickness of such a circumferential wall generally results in a halving of the hoop stress with respect to the same internal pressure value. Because the mufflers 20a, 20b, 20c of the present disclosure already have a significantly reduced radius/diameter (half) in comparison to a conventional muffler 5 of the prior art having the same internal volume, the thickness of the circumferential wall 24 of each of the disclosed mufflers 20a, 20b, 20c may be increased dramatically, including being more than doubled, while each of the resulting mufflers 20a, 20b, 20c having such a thickened circumferential wall 24 still occupies a significantly reduced cross-sectional packaging area bounded by the enlarged outer circumferential surface 25 thereof in comparison to the circumferential wall defining the expansion chamber of such a conventional muffler 5. The mufflers 20a, 20b, 20c as disclosed herein may thus be utilized in circumstances where especially high pressures are expected to be encountered therein, which facilitates the use of refrigerants that normally circulate at relatively high-pressure values with respect to such mufflers 20a, 20b, 20c, such as is the case for an R744 refrigerant composed of carbon dioxide (CO2). The ability to accommodate a high-pressure refrigerant such as R744 is also an environmentally friendly option in comparison to the use of a fluorinated refrigerant, thereby promoting the adoption of the use of naturally occurring refrigerants and avoidance of refrigerants that pose risks such as ozone layer depletion and introduction of relatively harmful greenhouse gases to the ambient environment.

It should be clearly noted herein that the mufflers 20a, 20b, 20c disclosed in FIGS. 2, 3, and 4C-4E are in no way limiting to the present invention, as the same beneficial relationships may be realized when utilizing alternative dimensions and/or ratios of such dimensions with respect to different embodiments of such mufflers 20a, 20b, 20c. That is, the exemplary mufflers 20a, 20b, 20c described herein were selected to show that advantageous characteristics may be achieved via the use of an elongate pipe or conduit structure having first and second ports 35, 36 formed at an inner circumferential surface 26 thereof and positioned away from the first and second axial end walls 27, 28 while still occupying the same total volume as the conventional muffler 5 being compared thereto, but the dimensions disclosed in testing such mufflers 20a, 20b, 20c in comparison to the more conventional configurations of the mufflers 5, 6 are not necessarily critical to or limiting to the operation of such mufflers 20a, 20b, 20c. As such, the refrigerant muffler 20 as broadly disclosed herein may include different dimensions of the inner diameter Dᵢ, the total length L_{T}, the distance of spacing Lᵢ of the first port 35 from a corresponding axial end wall 27, 28, and/or the distance of spacing Lₒ of the second port 36 from the same axial end wall 27, 28 without departing from the scope of the present invention. Similarly, the ratio of the total length L_{T} relative to any one of the inner diameter Dᵢ, the distance of spacing Lᵢ of the first port 35 from a corresponding axial end wall 27, 28, and/or the distance of spacing Lₒ of the second port 36 from the same axial end wall 27, 28 may also be varied in accordance with the present disclosure.

In contrast to the conventional muffler 5 of the prior art, which includes a total length L_{T} of less than twice the inner diameter Dᵢ of the expansion chamber thereof, the total length L_{T} of the muffler 20 according to the present invention may be selected to be at least 5 times the inner diameter Dᵢ, at least 10 times the inner diameter Dᵢ, or within a range of being 5 to 30 times the inner diameter Dᵢ, thereby establishing the elongated structure of the muffler 20 relative to the conventional muffler 5. Although the first port 35 is generally described as being centrally located, the first port 35 need not be spaced at exactly equal distances along the central axis of the hollow interior 23 from each of the axial end walls 27, 28, and may be disposed anywhere within a centrally disposed region of the hollow interior 23 covering about 10% of the total length L_{T} of the hollow interior 23. That is, in other words, the first port 35 may be spaced apart from either of the axial end walls 27, 28 by a distance ranging from 45% to 55% of the total length L_{T} while remaining within such a central region thereof. Additionally, the present invention may generally include the distance of spacing Lₒ at which the second port 36 is axially spaced apart from the second axial end wall 28 being 5% to 45% of the total length L_{T} of the hollow interior 23 of the muffler 20, wherein particularly beneficial results may be found when the distance Lₒ is 20% to 35% of the total length L_{T}. Embodiments of the present invention may include the inner diameter Dᵢ of the hollow interior 23 provided to be 0.75 inches (19 mm) to 2 inches (50.8 mm) across and may further include the total length L_{T} of the hollow interior 23 to be 200 mm to 1000 mm long. It should be readily apparent that variations of such dimensions and/or ratios of dimensions may result in different curves of transmission loss from those depicted in FIG. 5, wherein such dimensions and ratios of dimensions may be selected in accordance with a desired packaging space occupied by the resulting muffler 20, a desired strength or durability of the muffler 20 in withstanding internal pressures, a desired improvement of transmission loss along a desired range of frequencies, an ease of manufacturing of the resulting muffler 20 via the use of existing tooling or methods in forming such pipe-like or conduit-like structures, and combinations thereof, as desired.

It has also been surprisingly discovered that the configuration of the muffler 20 as disclosed herein does not require that a central axis of the hollow interior 23 thereof (identified by broken lines within each cross-sectional image provided herein and defined by a center of the cross-section of the circumferential wall 24) must extend rectilinearly along a single spatial direction to achieve the beneficial results outlined in FIG. 5 and described hereinabove. That is, the elongate pipe-like or conduit-like shape of the muffler 20 need not be straight such that the muffler 20 occupies a continuous cylindrical packaging space that extends in a single spatial direction along the entire length of the muffler 20 as measured between the opposing axial end walls 27, 28 thereof, wherein such a requirement would otherwise result in a limiting of possible packaging configurations of the muffler 20 along one spatial direction due to the increased total length of the muffler 20 in comparison to the muffler 5 of conventional design (with respect to such differing muffler configurations employing the same internal volume). Instead, it has been discovered that substantially the same attenuation of noise, vibration, and harshness may be achieved with respect to the disclosed configuration of the muffler 20 where a central axis of the hollow interior 23 includes one or more curves or bends therein when extending between the opposing ends 21, 22 and corresponding axial end walls 27, 28 of the muffler 20, thereby allowing for the muffler 20 to take on the configuration of a curved/bent pipe/conduit that is closed at each of the opposing axial ends thereof, so long as the positioning of the first and second ports 35, 36 remains the same with regards to the spacing of such features along the central axis of the hollow interior 23 and relative to the longitudinal or axial direction of the muffler 20 as measured from either of the opposing axial end walls 27, 28. In other words, the results outlined in FIG. 5 with respect to the mufflers 20a, 20b, 20c would not be expected to change dramatically even when curved or inclined segments are introduced into such mufflers 20a, 20b, 20c following the formation of the rectilinear and elongate structures shown in FIGS. 4C-4E.

Accordingly, the described longitudinal direction or the described axial direction of the muffler 20 of the present invention need not refer to a fixed spatial direction extending rectilinearly along the length of the muffler 20 but may instead refer to the localized direction of extension of the central axis of the hollow interior 23 at any position along the central axis when progressing between the opposing axial end walls 27, 28 of the muffler 20. A bending or curving of the circumferential wall 24 of the muffler 20 may accordingly result in the longitudinal/axial direction of the muffler 20 along some segments thereof being disposed at substantially any angle relative to the longitudinal/axial direction of other segments thereof when progressing along the central axis of the hollow interior 23 in a common direction of progression therealong, such as progressing from the first axial end wall 27 towards the second axial end wall 28 along the central axis of the hollow interior 23, or alternatively progressing from the second axial end wall 28 towards the first axial end wall 27 along the central axis of the hollow interior 23, including various segments being arranged at acute angles, 90 degree angles, obtuse angles, 180 degree angles (corresponding to parallel and opposing directions of extension with respect to a common direction of progression), or greater than 180 degree angles relative to each other, as desired or necessary.

The ability to alter the configuration of such mufflers 20a, 20b, 20c while maintaining the attenuation of desirable ranges of frequencies of acoustic waves mitigates against any potential disadvantages of utilizing a relatively long length of such mufflers 20a, 20b, 20c in comparison to the muffler 5 of conventional design while having the same internal volume. That is, the ability to route such an elongate structure via the introduction of such bends, curves, inclines, or turns results in the ability to fit the elongate structure around or between adjacent components of the vehicle absent the need for a continuous packaging space along the increased length dimension of a purely cylindrical structure.

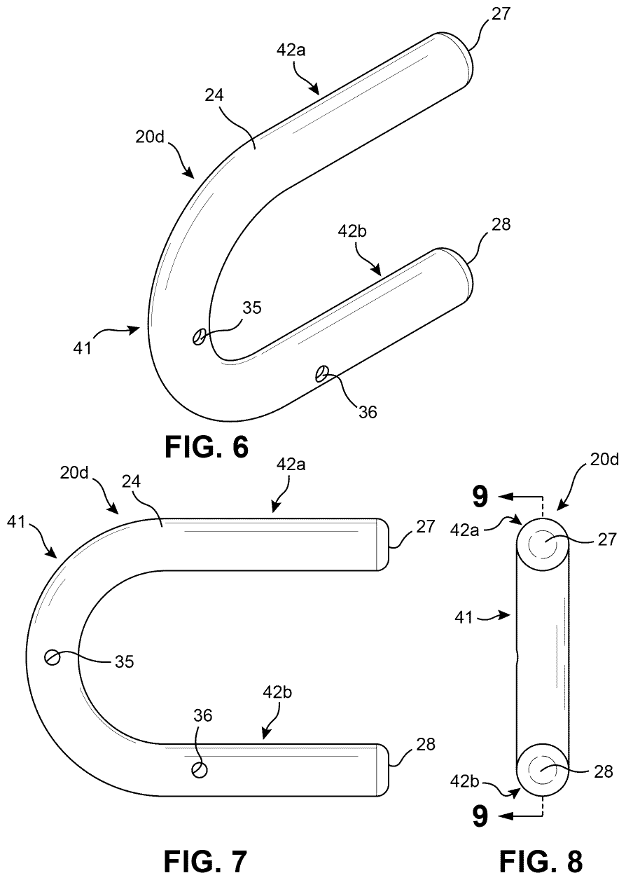

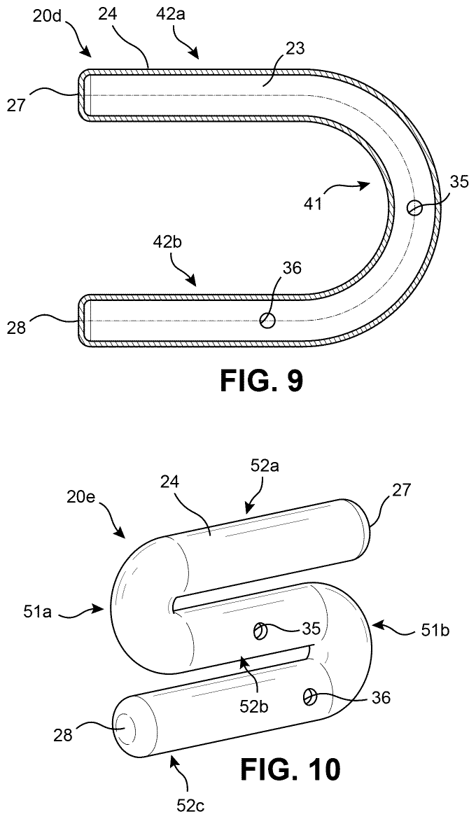

Referring now to FIGS. 6-9, a muffler 20d according to another embodiment of the present invention is disclosed. The muffler 20d includes the same general configuration as the muffler 20 of FIGS. 2 and 3 except that the central axis of the hollow interior 23 of the muffler 20d is substantially U-shaped in configuration to result in the muffler 20d, and more particularly the circumferential wall 24 thereof, comprising an arcuate segment 41 connecting two straight (rectilinear) segments 42a, 42b, wherein a distal end of each of the respective straight segments 42a, 42b includes a corresponding one of the axial end walls 27, 28 formed opposite a junction of the respective straight segment 42a, 42b with a respective end of the arcuate segment 41. The arcuate segment 41 includes the central axis of the hollow interior 23 extending through 180 degrees of curvature to result in a semi-circular shape having opposing ends with each of the opposing ends of the semi-circular shape transitioning to one of the straight segments 42a, 42b. The disclosed configuration results in the central axis of the hollow interior 23 along the straight segment 42a being spaced apart from and arranged parallel to the central axis of the hollow interior 23 along the straight segment 42b. When progressing along the central axis of the hollow interior 23 along the entire length of the muffler 20d, such as progressing from the first axial end wall 27 towards the second axial end wall 28, or vice versa, the direction of extension of the straight segment 42a is spatially opposite the direction of extension of the straight segment 42b.

The muffler 20d as shown may include the following dimensions, which differ slightly from those utilized in the experimentation associated with the mufflers 20a, 20b, 20c, but still results in similarly advantageous results. The total length of the central axis of the hollow interior 23 (analogous to the total length T_{L}) may be about 420-424 mm, the distance of the first port 35 from the second end wall 28 along the central axis of the hollow interior 23 (analogous to the length Lᵢ) may be about 110-112 mm, the distance of the second port 36 from the second end wall 28 along the central axis of the hollow interior 23 (analogous to the length Lₒ) may be about 98-100 mm, the inner diameter of the hollow interior 23 (analogous to the inner diameter Dᵢ) may be about 22 mm, the inner diameter of each of the ports 35, 36 may be about 8 mm, the thickness of the circumferential wall 24 and/or each of the axial end walls 27, 28 may be about 3 mm, and the radius of curvature of the central axis of the hollow interior 23 along the arcuate segment 41 may be about 60-61 mm. The disclosed dimensions result in the distance between the second axial end wall 28 and the first port 35 along the central axis of the hollow interior 23 being about half of the total length of the muffler 20d along the central axis of the hollow interior 23, as well as the distance of the second end wall 28 from the second port 36 along the central axis of the hollow interior 23 being about 23-24% of the total length of the muffler 20d along the central axis of the hollow interior 23, wherein such relationships most closely correspond to the experimental results illustrated with respect to the muffler 20b of FIG. 4D, which beneficially includes the same or improved values of transmission loss across all relevant frequencies in comparison to the conventional muffler 5 along with the formation of localized peaks of transmission loss at certain relatively low operating frequencies, such as between about 180 Hz to about 200 Hz.

The disclosed U-shaped configuration of the muffler 20d beneficially allows for the muffler 20d to be integrated into a corresponding vehicle in a manner wherein the U-shaped opening formed between the segments 41, 42a, 42b is able to wrap around or receive another component therein, such as receiving a correspondingly cylindrical structure within the arcuate segment 41 or an elongate component between the straight segments 42a, 42b, as non-limiting examples. The muffler 20d is accordingly adaptable to a variety of different packaging configurations while maintaining desirable characteristics of noise attenuation.

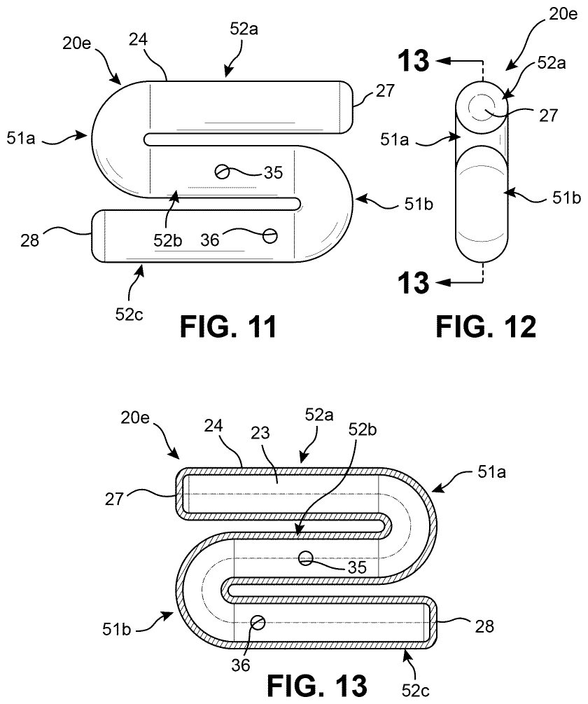

Referring now to FIGS. 10-13, a muffler 20e according to another embodiment of the present invention is disclosed. The muffler 20e is substantially similar in many respects to the muffler 20d of FIGS. 6-9 except that the central axis of the hollow interior 23 is bent into an S-shape including two arcuate segments 51a, 51b connecting three spaced apart straight segments 52a, 52b, 52c. The muffler 20e is similar to the muffler 20d in that the total length of the central axis of the hollow interior 23 (analogous to the total length T_{L}) of the muffler 20e may be about 420-424 mm, the distance of the first port 35 from the second axial end wall 28 along the central axis of the hollow interior 23 (analogous to the length Lᵢ) may be about 110-112 mm, the distance of the second port 36 from the second axial end wall 28 along the central axis of the hollow interior 23 (analogous to the length Lₒ) may be about 98-100 mm, the inner diameter of the hollow interior 23 (analogous to the inner diameter Dᵢ) may be about 22 mm, the inner diameter of each of the ports 35, 36 may be about 8 mm, and the thickness of the circumferential wall 24 and/or each of the axial end walls 27, 28 may be about 3 mm. The muffler 20e differs from the muffler 20d in that the radius of curvature of each of the arcuate segments 51a, 51b may be about 18-19 mm, thereby resulting in tighter bends in forming the disclosed S-shape and thus closer spacing of the straight segments 52a, 52b, 52c. The muffler 20e once again operates in similar fashion to the muffler 20b of FIG. 4D as a result of similar ratios being present between the relevant dimensions for prescribing a transmission loss curve similar to that disclosed with respect to the muffler 20b as shown in FIG. 5.

The formation of the muffler 20e into the disclosed S-shape offers yet another advantage in packaging the muffler 20e within a corresponding vehicle due to the resulting S-shape occupying a substantially rectangular-cuboid shape that has a reduced profile in comparison to the diameter of the conventional muffler 5 of the prior art, which results in the ability to fit the muffler 20e into relatively narrow rectangular-cuboid openings or slots presented between adjacent components occupying the packaging space of the vehicle. The use of two arcuate segments 51a, 51b also reduces the maximum dimension of the muffler 20e with respect to the direction of extension of each of the straight segments 52a, 52b, 52c thereof, which mitigates against the concerns relating to packaging a particularly elongate structure such as any one of the mufflers 20a, 20b, 20c presented as being devoid of any bends as shown in FIGS. 4C-4E.

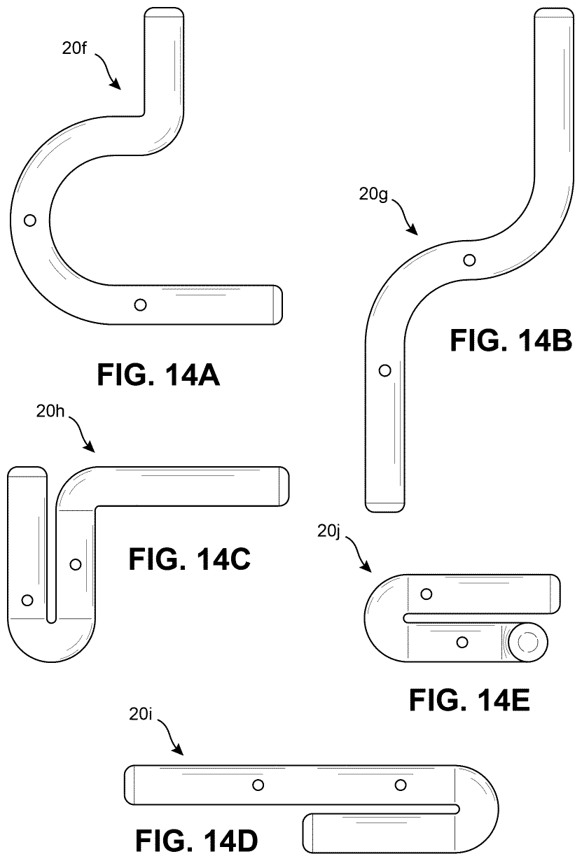

Finally, FIGS. 14A-14E illustrate various examples of additional potential configurations of mufflers 20f, 20g, 20h, 20i, 20j in accordance with the present disclosure, wherein each of the disclosed mufflers 20f, 20g, 20h, 20i, 20j includes a unique combination of the arcuate segments and straight segments such as those shown and described with respect to any of FIGS. 6-13 for achieving any of a number of different packaging configurations that may be necessary in attempting to position and orient such mufflers 20f, 20g, 20h, 20i, 20j within a corresponding vehicle. Each of the illustrated mufflers 20f, 20g, 20h, 20i, 20j may include the same dimensions as disclosed with regards to each of the mufflers 20d, 20e such that each of the mufflers 20f, 20g, 20h, 20i, 20j includes the total length of the central axis of the hollow interior 23 (analogous to the total length T_{L}) being about 420-424 mm, the distance of the first port 35 from the second end wall 28 along the central axis of the hollow interior 23 (analogous to the length Lᵢ) being about 110-112 mm (half the total length), the distance of the second port 36 from the second axial end wall 28 along the central axis of the hollow interior 23 (analogous to the length Lₒ) being about 98-100 mm (again corresponding to be about 23-24% of the total length of each of the mufflers 20f, 20g, 20h, 20i, 20j along the central axis of the hollow interior 23), the inner diameter of the hollow interior 23 (analogous to the inner diameter Dᵢ) being about 22 mm, the inner diameter of each of the ports 35, 36 being about 8 mm, and the thickness of the circumferential wall 24 being about 3 mm. Each illustrated arcuate segment is also depicted as having a radius of curvature of either about 60-61 mm (corresponding to that of the arcuate segment 41) or about 18-19 mm (corresponding to that of each of the arcuate segments 51a, 51b), although different radii of curvature may be utilized in forming such bent or curved configurations while remaining within the scope of the present invention.

Of note in comparison to previously described embodiments of the mufflers 20a, 20b, 20c, 20d, 20e, each of the mufflers 20f, 20h, and 20j includes at least one of the straight segments thereof arranged at a 90 degree angle relative to another one of the straight segments thereof to create unique shapes that may be adapted for installation within irregularly shaped openings within a corresponding vehicle, such as forming portions of each of the mufflers 20f, 20h, 20j to be substantially L-shaped or J-shaped for wrapping around corners or edges of adjacent components. The muffler 20f is distinguishable from prior disclosed examples by including arcuate segments of differing radii of curvature as may be necessary in routing the muffler 20f through a corresponding packaging space, such as routing the muffler 20f through or adjacent a combination of cylindrical components and cuboid-shaped components within the vehicle, as one non-limiting installation configuration. The mufflers 20f, 20h, 20i, and 20j are distinguishable from prior disclosed examples by including a different length among the two straight segments forming the distal-most end segments of each such muffler 20f, 20h, 20i, 20j, thereby facilitating the ability to fit each such distal-most end segment into an opening or space of varying length when installing each such muffler 20f, 20h, 20i, 20j into a correspondingly irregular packaging space. The muffler 20g is distinguishable from prior disclosed examples by including the extension of each corresponding straight segment thereof in a common spatial direction (when progressing between the opposing axial end walls thereof) while offset laterally from one another, thereby presenting an elongate structure having a central region that can be routed between two adjacent components while the laterally offset straight segments projecting from the central region can be routed to opposing sides of said components. Lastly, the muffler 20j uniquely discloses the use of two or more arcuate segments curving around perpendicular arranged axes for facilitating any number of 3-dimensional shapes where the central axis of the muffler 20j is not disposed exclusively on a single plane but can instead include the central axis arranged on multiple different planes arranged at inclines relative to one another. The use of any such features disclosed throughout FIGS. 14A-14D, whether utilized alone or in combination, thereby promotes a flexibility of design of such a muffler for mitigating against any concerns relating to the need to accommodate the elongate configuration of the mufflers as disclosed herein when attempting to install or package such mufflers within a corresponding vehicle.

The shape and configuration of the hollow interior 23 of each of the mufflers disclosed herein may also advantageously be integrated into various components associated with the HVAC system of a corresponding vehicle while still appreciating the benefits of the mufflers described herein. For example, a housing or a mounting structure associated with an adjacent component of the refrigerant circuit 10, such as the housing of the condenser 13 disposed downstream of the refrigerant muffler 20 of FIG. 1, may be formed to include a cylindrical opening therein that has the same configuration as the hollow interior 23 of any embodiments of mufflers as shown and described herein, wherein such a cylindrical opening may be closed off at each opposing axial end and may be fluidly coupled to additional openings formed in such a structure that operate as the first and second ports 35, 36 according to the present invention.

As another example, such a component having an integrated muffler configuration may be formed by two or more housing structures that each partially define the shape of the hollow interior 23, such as two cooperating housing structures having semi-cylindrical openings formed therein that meet at a seam in defining the shape of the disclosed hollow interior 23. Such an example may further include the formation of the first and second ports 35, 36 within one or more such housing components for fluidly communicating with the cylindrical shape formed by the cooperation of such housing components. In other words, the configurations of the mufflers as shown and described herein need not necessarily be provided as pipes, tubes, or conduits that are positioned and mounted relative to adjacent components of the vehicle for accommodating a packaging space provided therebetween, but may instead be provided as monolithic or integrated features of any component of the vehicle having a configuration and position suitable for accommodating the inclusion of an open space corresponding the hollow interior 23 and open connecting spaces corresponding to the ports 35, 36 while maintaining the same benefits of the present invention. With renewed reference to FIGS. 2 and 3, one such example of cooperating structures may include the division of the muffler 20 as cut along a plane defined by section lines 3-3 in FIG. 2 with an outer disposed structure of the cooperating structures corresponding to the portion of the muffler 20 shown in FIG. 3 including the ports 35, 36 positioned outwardly for connection to the remainder of the refrigerant circuit.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A refrigerant muffler comprising:
an elongate hollow interior defined by cooperation of an inner circumferential surface of an axially extending circumferential wall, a first axial end wall disposed at a first axial end of the circumferential wall, and a second axial end wall disposed at a second axial end of the circumferential wall opposite the first axial end thereof;
a first port for conveying a refrigerant into or out of the hollow interior of the refrigerant muffler, the first port provided as a first opening extending through the circumferential wall to the inner circumferential surface thereof; and
a second port for conveying the refrigerant into or out of the hollow interior of the refrigerant muffler, the second port provided as a second opening extending through the circumferential wall to the inner circumferential surface thereof, wherein the first port is axially spaced apart from each of the first axial end wall and the second axial end wall, and wherein the second port is axially spaced apart from each of the first axial end wall and the second axial end wall.

2. The refrigerant muffler of claim 1, wherein the circumferential wall is cylindrical in shape.

3. The refrigerant muffler of claim 1, wherein the first opening forming the first port is cylindrical in shape and the second opening forming the second port is cylindrical in shape.

4. The refrigerant muffler of claim 1, wherein the first opening forming the first port extends in a radial direction of the circumferential wall arranged perpendicular to the axial direction thereof and the second opening forming the second port extends in the radial direction of the circumferential wall arranged perpendicular to the axial direction thereof.

5. The refrigerant muffler of claim 1, wherein an inner diameter of the first opening forming the first port and an inner diameter of the second opening forming the second port are each between 15-40% of an inner diameter of the hollow interior as defined by the inner circumferential surface of the circumferential wall.

6. The refrigerant muffler of claim 1, wherein a total length of the hollow interior, as measured along a central axis of the hollow interior between the first axial end wall and the second axial end wall, is at least 5 times greater than an inner diameter of the hollow interior as defined by the inner circumferential surface of the circumferential wall.

7. The refrigerant muffler of claim 1, wherein a total length of the hollow interior, as measured along a central axis of the hollow interior between the first axial end wall and the second axial end wall, is 5 to 30 times greater than an inner diameter of the hollow interior as defined by the inner circumferential surface of the circumferential wall.

8. The refrigerant muffler of claim 1, wherein the first port is positioned within a central region of the hollow interior with respect to the axial direction of the circumferential wall to result in an axial distance at which the first port is spaced apart from the second axial end wall, as measured along a central axis of the hollow interior, being 45% to 55% of a total length of the hollow interior as measured along the central axis of the hollow interior between the first axial end wall and the second axial end wall.

9. The refrigerant muffler of claim 8, wherein the second port is positioned axially between the first port and the second axial end wall, and wherein an axial distance at which the second port is spaced apart from the second axial end wall, as measured along the central axis of the hollow interior, is 5% to 45% of the total length of the hollow interior as measured along the central axis of the hollow interior between the first axial end wall and the second axial end wall.

10. The refrigerant muffler of claim 8, wherein the second port is positioned axially between the first port and the second axial end wall, and wherein an axial distance at which the second port is spaced apart from the second axial end wall, as measured along the central axis of the hollow interior, is 20% to 35% of the total length of the hollow interior as measured along the central axis of the hollow interior between the first axial end wall and the second axial end wall.

11. The refrigerant muffler of claim 1, wherein the first opening forming the first port and the second opening forming the second port are formed to a common diametric side of the inner circumferential surface of the circumferential wall.

12. The refrigerant muffler of claim 1, wherein the circumferential wall comprises at least one straight segment and at least one arcuate segment as the circumferential wall extends axially between the first axial end wall and the opposing second axial end wall.

13. The refrigerant muffler of claim 12, wherein the circumferential wall is formed into a U-shaped configuration when extending axially between the first axial end wall and the opposing second axial end wall.

14. The refrigerant muffler of claim 12, wherein the circumferential wall is formed into an S-shaped configuration when extending axially between the first axial end wall and the opposing second axial end wall.

15. The refrigerant muffler of claim 12, wherein the circumferential wall is formed into at least one of an L-shaped configuration or a J-shaped configuration when extending axially between the first axial end wall and the opposing second axial end wall.

16. The refrigerant muffler of claim 12, wherein the at least one arcuate segment includes a first arcuate segment curving around a first axis and a second arcuate segment curving around a second axis, and wherein the first axis and the second axis are not parallel to each other.

17. A refrigerant muffler comprising:
an elongate hollow interior defined by cooperation of an inner circumferential surface of an axially extending circumferential wall, a first axial end wall disposed at a first axial end of the circumferential wall, and a second axial end wall disposed at a second axial end of the circumferential wall opposite the first axial end thereof;
a first port for conveying a refrigerant into or out of the hollow interior of the refrigerant muffler, the first port provided as a first opening extending through the circumferential wall to the inner circumferential surface thereof; and
a second port for conveying the refrigerant into or out of the hollow interior of the refrigerant muffler, the second port provided as a second opening extending through the circumferential wall to the inner circumferential surface thereof, wherein the first port is positioned within a central region of the hollow interior with respect to the axial direction of the circumferential wall to result in an axial distance at which the first port is spaced apart from the second axial end wall, as measured along a central axis of the hollow interior, being 45% to 55% of a total length of the hollow interior as measured along the central axis of the hollow interior between the first axial end wall and the second axial end wall, wherein the second port is positioned axially between the first port and the second axial end wall, wherein an axial distance at which the second port is spaced apart from the second axial end wall, as measured along a central axis of the hollow interior, is 5% to 45% of the total length of the hollow interior as measured along the central axis thereof between the first axial end wall and the second axial end wall, and wherein the total length of the hollow interior is 5 to 30 times greater than an inner diameter of the hollow interior as defined by the inner circumferential surface of the circumferential wall.

18. The refrigerant muffler of claim 17, wherein the circumferential wall comprises at least one straight segment and at least one arcuate segment as the circumferential wall extends axially between the first axial end wall and the opposing second axial end wall.

19. The refrigerant muffler of claim 18, wherein the circumferential wall is formed into at least one of a U-shaped configuration, an S-shaped configuration, an L-shaped configuration, or a J-shaped configuration when extending axially between the first axial end wall and the opposing second axial end wall.

20. A refrigerant circuit including, in an order of flow of a refrigerant during circulation thereof through the refrigerant circuit, a compressor, a refrigerant muffler, a condenser, an expansion element, and an evaporator, the refrigerant muffler comprising:
an elongate hollow interior defined by cooperation of an inner circumferential surface of an axially extending circumferential wall, a first axial end wall disposed at a first axial end of the circumferential wall, and a second axial end wall disposed at a second axial end of the circumferential wall opposite the first axial end thereof;
a first port for conveying the refrigerant into the hollow interior of the refrigerant muffler after exiting from a high-pressure side of the compressor and before entering the condenser, the first port provided as a first opening extending through the circumferential wall to the inner circumferential surface thereof; and
a second port for conveying the refrigerant out of the hollow interior of the refrigerant muffler and towards the condenser, the second port provided as a second opening extending through the circumferential wall to the inner circumferential surface thereof, wherein the first port is axially spaced apart from each of the first axial end wall and the second axial end wall, and wherein the second port is axially spaced apart from each of the first axial end wall and the second axial end wall.
